(19) United States
(12) Patent Application Publication
(10) Pub. No.: US 2007/0146507 A1
(43) Pub. Date: Jun. 28, 2007

(54) Method of controlling an image forming system and an image forming system

(75) Inventor: Sa-bong Jeong, Suwon-si (KR)

Correspondence Address: STEIN, MCEWEN & BUI, LLP, 1400 EYE STREET, NW, SUITE 300, WASHINGTON, DC, 20005, US

(73) Assignee: Samsung Electronics Co., Ltd., Suwon-si (KR)

(21) Appl. No.: 11/541,746

(22) Filed: Oct. 3, 2006

(30) Foreign Application Priority Data
Dec. 28, 2005 (KR) 2005-131943

(51) Int. Cl. H04N 5/217

(52) U.S. Cl. 348/241

(57) ABSTRACT

A method of controlling an image forming system and an image forming system. The method includes: receiving a printing data according a command for interpolation printing for printing by interpolating an image; analyzing the received printing data and deciding an interpolation type; and interpolating the image according to the decided interpolation type and printing the image. Accordingly, it is possible to improve quality of the interpolated image and save resources and time necessary for interpolating the image.

### CROSS-REFERENCE TO RELATED APPLICATIONS

This application claims the benefit of Korean Application No. 2005-131943, filed Dec. 28, 2005, in the Korean Intellectual Property Office, the disclosure of which is incorporated herein by reference.

### BACKGROUND OF THE INVENTION

1. Field of the Invention

Aspects of the present invention relate to a method of controlling an image forming system and an image forming system. More particularly, aspects of the present invention relate to a method of controlling an image forming system and an image forming system, which selectively applies an appropriate interpolation type according to a type of an image, and performs printing in accordance with the appropriate interpolation type.

2. Description of the Related Art

In conventional image forming systems, lines connected in series or in parallel with an information processing device such as a computer, an image forming system such as a general printer, and a multifunctional printer (MFP) transmit data to and receive data from the information processing device, receive printing data from the information processing device, and print the printing data on paper.

The printing data printed by the image forming system may include text and/or images, the images being largely classified into graphical images and photographical images.

Recently, increasing numbers of users have desired to be able to enlarge and print the graphical images generated by the use of various application programs. Also users have desired to be able to enlarge and print the photographical images, such as a photo taken by a digital camera.

Generally, an interpolation type is used to interpolate the image to be enlarged and/or printed. Interpolating the image refers to determining pixel values of each pixel of interpolation image data by use of pixel values of each pixel of target image data stored in a bitmap. The interpolation type includes a zero-order interpolation type, a bilinear interpolation type, and a bicubic interpolation type.

The zero-order type refers to copying pixel values of each pixel of the target image data so as to determine pixel values of each pixel of the interpolated image data. For example, when the image is interpolated to be enlarged to a size that is twice as big as the image was, the interpolated image data is copied with pixel values of each pixel of the target image to be interpolated twice in vertical and horizontal directions.

The bilinear type and bicubic type make calculations of a predetermined pixel of the target image to be interpolated while referring to the pixel value, and determine new pixel values of each pixel of the interpolated image data. Accordingly, the bilinear type and bicubic type consume more calculation resources and time during processing than the zero-order type. However, since edges are not emphasized on the bilinear type and bicubic type interpolated image, the image being interpolated ends up being expressed softly in an overall sense.

FIG. 1 is a view of an interpolated photo generation type image 100 and a graphic generation type image 110 according to the zero-order type and the bilinear type methods, respectively. In each case, the images are interpolated to be five (5) times as big as they were. As shown in FIG. 1, the zero-order type and the bilinear type methods produce different effects on the graphic generation type image and the photo generation type image. That is, the zero-order type emphasizes clear edges and is effective in the graphic generation type image, and the bilinear type expresses soft edges and is effective in the photo generation type image.

However, in the related art, an interpolation type is selected according to a type of a printer driver being used. In other words, the interpolation type is not determined based on whether a graphical image or a photographical image is being interpolated, This is true despite the fact that while the zero-order type method provides quicker processing, photographical images are degraded, and the fact that, while, the bilinear type and bicubic type methods provide slower processing, graphical images are degraded.

### SUMMARY OF THE INVENTION

An aspect of the present invention is to solve at least the above and/or other problems and disadvantages of the related art and to provide at least the advantages described below. Accordingly, aspects of the present invention provide a method of controlling an image forming system and an image forming system, which selectively applies a type of an interpolation according to whether an image is a graphical image or a photographical image in order to interpolate the image.

In order to achieve the above-described and/or other aspects of the present invention, there is provided a method of controlling an image forming system comprising: receiving printing data according to a command for interpolation printing; analyzing the received printing data and determining an interpolation type; and interpolating the image according to the determined interpolation type and printing the image.

The interpolation type includes a zero-order type, a bilinear type, and a bicubic type. The printing data is one of a graphical image and a photographical image. Whether the printing data is a graphical image or a photographical image is judged using a histogram of the printing data. If the printing data is determined to be graphical, the zero-order type is determined to be the interpolation type. If the printing data is determined to be photographic, one of the bilinear type and the bicubic type is determined to be the interpolation type.

The control method further comprises inputting the command for interpolation printing for interpolating and printing the image, and providing a user interfacing to allow for a selection of the interpolation type.

The operation of deciding the interpolation type is performed by one of an image forming system or a host apparatus.

Additional and/or other aspects and advantages of the invention will be set forth in part in the description which follows and, in part, will be obvious from the description, or may be learned by practice of the invention.

### BRIEF DESCRIPTION OF THE DRAWINGS

These and/or other aspects and advantages of the invention will become apparent and more readily appreciated from the following description of the embodiments, taken in conjunction with the accompanying drawings of which:

FIG. 1 is a view comparing general image interpolation types;

FIG. 2 is a block diagram of an image forming system according to an embodiment of the present invention;

FIGS. 3A and 3B are block diagrams of an image forming system according to another embodiment of the present invention;

FIG. 4 is a flowchart explaining a control method of the image forming system of the present invention; and

FIG. 5 through 6B are views provided to explain the control method of the image forming system of the present invention.

### DETAILED DESCRIPTION OF THE EMBODIMENTS

Reference will now be made in detail to the present embodiments of the present invention, examples of which are illustrated in the accompanying drawings, wherein like reference numerals refer to the like elements throughout. The embodiments are described below in order to explain the present invention by referring to the figures.

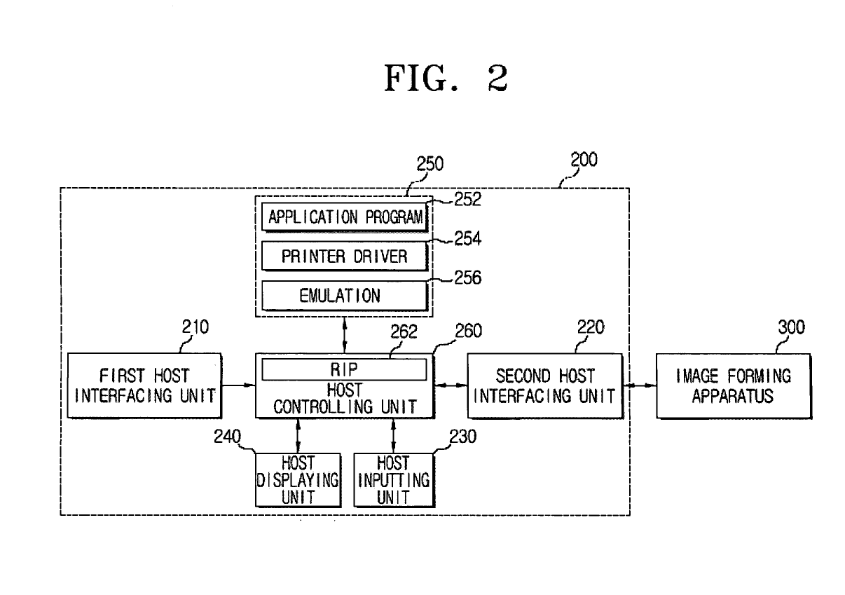

FIG. 2 is a block diagram of an image forming system according to an embodiment of the present invention. As shown in FIG. 2, an image forming system includes an image forming apparatus 300 and a host apparatus 200. The image forming apparatus 300 may comprise a device, such as a printer or a multifunctional printer (MFP). The host apparatus 200 may be a device, such as a desktop computer, a laptop, a personal digital assistant (PDA), or a combination thereof. However, the image forming apparatus 300 and the host apparatus 200 may, of course, comprise other devices.

The host apparatus 200 and the image forming apparatus 300 are connected through a wired or wireless local area network (LAN), and, as such, are able to communicate data back and forth. Thus, the image forming apparatus 300 is able to receive printing data from the host apparatus 200 and to print the received data.

The host apparatus 200 includes a first host interfacing unit 210, a second host interfacing unit 220, a host inputting unit 230, a host displaying unit 240, a host storing unit 250 and a host controlling unit 260. According to an embodiment of the invention, the host apparatus 200 is connected with an external device, such as a digital camera, through the first host interfacing unit 210, so as to be able to receive an image from the external device. According to another embodiment of the invention, the host apparatus 200 is connected, through the second host interfacing unit 220, with the image forming apparatus 300 so that the host apparatus 200 and the image forming apparatus 300 are able to transmit various data information and a command signal to each other. The host interfacing units 210, 220 may be a universal serial bus (USB) port, a parallel port, a personal system/2 (PS2) port and/or a local area network (LAN) card.

A user inputs a user command into the host apparatus 200 through the host inputting unit 230. The host inputting unit 230 may comprise, for example, a key board and a mouse. According to an embodiment of the present invention, an interpolation type is selected through the host inputting unit 230 and a command for interpolation printing is input as a result. When the interpolation type is selected, the host controlling unit 260 controls an emulation 256 and a raster image processor (RIP) 258, of the host storing unit 250, to interpolate the image according to the selected interpolation type, and to generate the printing data. When the interpolation type is not selected, the host controlling unit 260 controls the emulation 256 and the RIP 258 to judge the type of the target image to be interpolated, to select the interpolation type according to the type of image being interpolated, and to interpolate the image and generate the printing data accordingly.

The host displaying unit 240 displays results of processing operations done at or by the host apparatus 200, to the user. The host displaying unit 240 may be a cathode-ray tube (CRT) monitor or a liquid crystal display (LCD) monitor. According to embodiments of the present invention, the host displaying unit 240 displays a printing option screen to allow for a selection of various options for printing provided by the printer driver 254, which is controlled by the host controlling unit 260. The printing option screen includes an interpolation type selection item to allow for a selection of an image interpolation type and an image interpolation ratio. If the interpolation type is not manually selected in the interpolation type selection item but set to be automatically selected, the host controlling unit 260 controls the emulation 256 and the RIP 262 to determine the type of image being interpolated, to determine the appropriate interpolation type based on the type of image, and to interpolate the image according to the determined interpolation type.

The host storing unit 250 includes a nonvolatile memory to store various control programs that are capable of operating the host apparatus 200 and a volatile memory to store data processed in operations of the various control programs. For example, the nonvolatile memory stores the application program 252, the printer driver 254 and the emulation 256.

When a command to print a target image, which is formed on the application program 252, is input through the host inputting unit 230, the printer driver 254 converts the target image into bitmap data that is recognizable by the image forming apparatus 300. The host controlling unit 260 loads the emulation 256, analyzes the bitmap data generated by the printer driver 254, and determines the interpolation type based on the analysis. The host controlling unit 260 determines an original size of the image and a size of the image to be interpolated according to the interpolation ratio. Accordingly, the RIP 262 in the host controlling unit 260 interpolates the image by use of the bitmap data generated by the printer driver 254. If the interpolation type is not selected, the RIP 262 uses the bitmap data, to determine the type of image being interpolated, to determine the interpolation type accordingly, and to interpolate the image.

The host controlling unit 260 controls the host apparatus 200. According to embodiments of the present invention, when a command for interpolation printing is input together with the image interpolation type and the image interpolation ratio, from the host inputting unit 230 through a user interface of the printing option screen provided by the printer driver 254, the host controlling unit 260 controls the printer driver 254 to generate the bitmap data and controls the emulation 256 and the RIP 262 to interpolate the image based on the inputted instructions. The host controlling unit 260 controls the interpolated image to be transmitted to the image forming apparatus 300 through the second host interfacing unit 220 and to be printed.

The image forming apparatus 300 prints the interpolated image on a recording medium (i.e., paper, transparency, etc.).

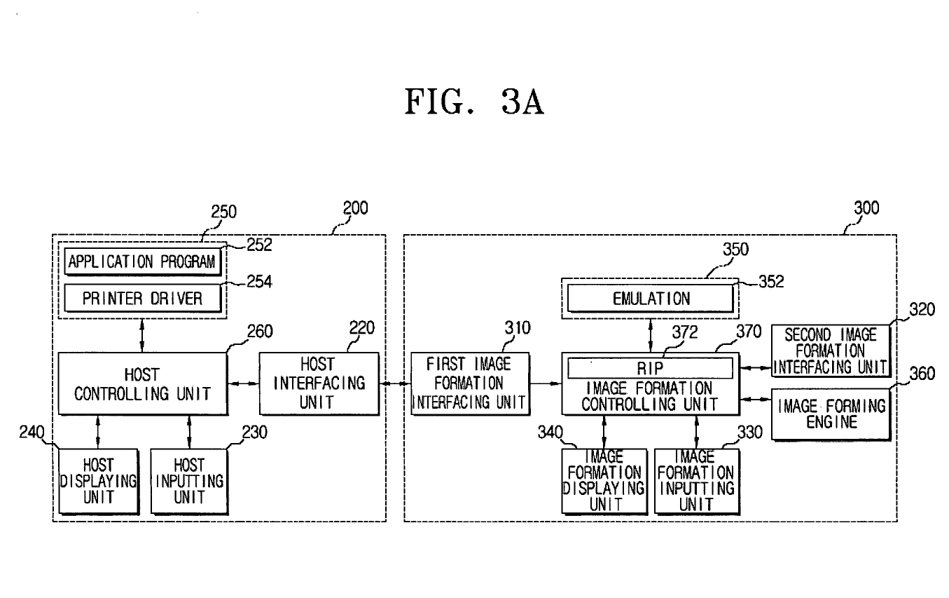

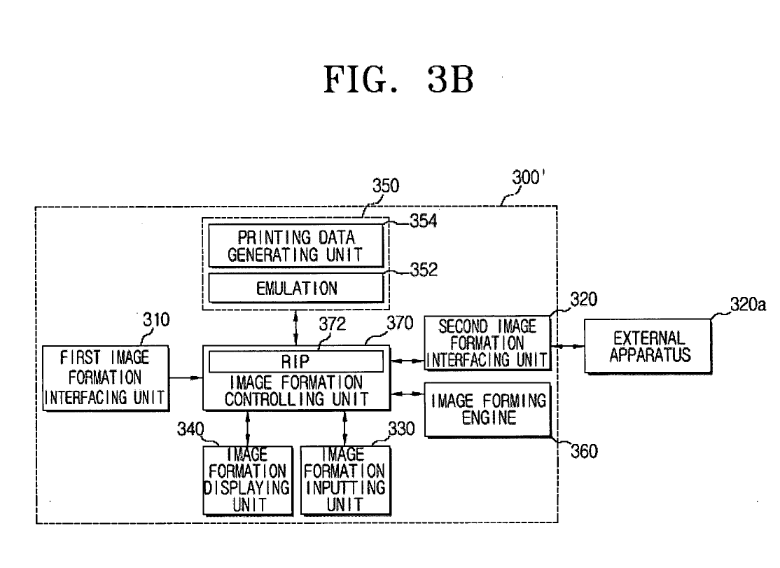

FIG. 3A is a block diagram of an image forming system according to another embodiment of the present invention.

When a command for interpolation printing of a target image formed on an application program 252 is input through a host inputting unit 230, a printer driver 254 in a host storing unit 250 converts the target image to be printed into a bitmap data that is recognizable by the image forming apparatus 300. The converted bitmap data is then transmitted to the image forming apparatus 300 through a host interfacing unit 220 that is controlled by a host controlling unit 260.

According to embodiments of the present invention, the image forming apparatus 300 includes a first image formation interfacing unit 310, a second image formation interfacing unit 320, an image formation inputting unit 330, an image formation displaying unit 340, an image formation storing unit 350, an image forming engine 360 and an image formation controlling unit 370.

The image forming apparatus 300 is connected to the host apparatus 200 through the first image formation interfacing unit 310 to receive the bitmap data. In addition, the image forming apparatus 300 is connected to an external device such as a digital camera through the second image formation interfacing unit 320 to receive the image.

A user inputs a user command into the image forming apparatus 300 through the host inputting unit 230 or the image formation inputting unit 330. The image formation inputting unit 330 may be one or more function keys and/or a touch screen. According to embodiments of the present invention, the command for interpolation printing is input through the image formation inputting unit 330. Based on the input command for interpolation printing, the image formation controlling unit 370 controls an emulation 352 and a raster image processor (RIP) 372 to interpolate the image received through the first image formation interfacing unit 310 or the image received through the second image formation interfacing unit 320 from an information processing apparatus 200.

The image formation displaying unit 340 displays a result of an operational performance of the image forming apparatus 300. The image formation displaying unit 340 may be a liquid crystal display (LCD) window. According to embodiments of the present invention, the image formation displaying unit 340 selects various printing options such as an interpolation type and an interpolation ratio under the control of the image formation controlling unit 370, and displays a user interface of a printing option screen to allow for an inputting of a command for interpolation.

The image formation storing unit 350 includes a nonvolatile memory that stores various control programs to operate the image forming apparatus 300, and a volatile memory that stores data processed when the various control programs operate. The nonvolatile program stores the emulation 352. When the bitmap data is transmitted from the host apparatus 200, the image formation controlling unit 370 loads the emulation 352 stored in the image formation storing unit 350, analyzes the bitmap data transmitted and determines the appropriate interpolation type so as to determine an original size of the image and a size of the size of the image to be interpolated according to the interpolation ratio. The RIP 372 in the image formation controlling unit 370 uses the received bitmap data, to interpolate the image. When the interpolation type is not selected, the RIP 372 judges the image generation type and determines the interpolation type accordingly, using the bitmap data, to interpolate the image.

The image forming engine 360 prints the interpolated image on paper through a predetermined printing process, under the control of the image formation controlling unit 370.

The image formation controlling unit 370 controls the overall operation of the image forming apparatus 300. According to other embodiments of the present invention, when a command for interpolation printing is input through the image formation inputting unit 330 according to the printing option screen displayed on the image formation displaying unit 340 together with the image interpolation type and the interpolation ratio that is selected, the image formation controlling unit 370 controls the emulation 352 and the RIP 372 to interpolate the image and print the interpolated image through the image forming engine 360.

FIG. 3B is a block diagram of an image forming system according to another embodiment of the present invention. As shown in FIG. 3B, an image forming apparatus 300′ is connected to an external device 320a such as a memory apparatus a digital camera, or a combination thereof, to communicate with and to transmit and receive data from the external device 320a.

The embodiment of FIG. 3B is different from the embodiment of FIG. 3A, in that the image forming apparatus 300′ receives printing data, not from a host apparatus, but from the external device 320A, to process various sets of data for printing. In the embodiment of FIG. 3B, descriptions of parts overlapping with the embodiment of FIG. 3A will be omitted.

A printing data generating unit 354 in an image formation storing unit 350 processes an image transmitted from the external device 320a or an image stored in the image formation storing unit 350, and converts the processed image into a bitmap data for printing at the image forming apparatus 300′, so as to generate the printing data.

According to the embodiment of the present invention, the image forming apparatus 300′ includes a first image formation interfacing unit 310, a second image formation interfacing unit 320, an image formation inputting unit 330, an image formation displaying unit 340, an image formation storing unit 350, an image forming engine 360 and an image formation controlling unit 370.

The image forming apparatus 300′ is connected to the external device 320a, such as a digital camera, through the second image formation interfacing unit 320, to receive the image.

A user inputs a user command into the image forming apparatus 300′ through the image formation inputting unit 330. According to the embodiment of the present invention, a command for interpolation printing is input together with various printing options such as an interpolation type and an interpolation ratio, through the image formation inputting unit 330.

To this end, the image formation displaying unit 340 selects the various printing options such as the interpolation type and the interpolation ratio, and displays a user interface of a printing option screen to allow for an inputting of a command for interpolation.

When the command for interpolation printing is input through the image formation inputting unit 330, the image formation controlling unit 370 controls the printing data generating unit 354 to convert the image transmitted from the external device and to generate the bitmap image data for printing.

The image formation controlling unit 370 controls an emulation 352 and a raster image processor (RIP) 372 according to various printing options input through the image formation inputting unit 330 together with the command for interpolation, such that the bitmap image data generated by the printing data generating unit 354 is interpolated.

The image forming storing unit 350 includes a nonvolatile memory that stores various control programs for operating the image forming apparatus 300 and a volatile memory that stores data that is processed when the various control programs are operated. For example, the nonvolatile memory stores the emulation 352 and the printing data generating unit 354. When the image is transmitted from the external device 320a, the image formation controlling unit 370 loads the printing data generating unit 354 stored in the image formation storing unit 350, and converts the transmitted image into the bitmap image data for printing. The image formation controlling unit 370 determines the appropriate interpolation type included in the printing option according to the command for interpolation input through the image formation inputting unit 330, to determine an original size of the image and a size of the image to be interpolated according to the interpolation ratio. The RIP 372 in the image formation controlling unit 370 interpolates the image using the generated bitmap image data. When the interpolation type is not selected, the RIP 372 uses the bitmap image data, to determine the type of the image being interpolated and determines the interpolation type based on the type of the image.

The image forming controlling unit 370 controls overall operations of the image forming apparatus 300. When the printing options, such as the image interpolation type and the image interpolation ratio, are selected and input together with the command for interpolation through the image formation inputting unit 330 according to the printing option screen displayed on the image formation displaying unit 340, the image formation controlling unit 370 controls the emulation 352, the printing data generating unit 354 and the RIP 372 to interpolate the image transmitted from the external device 320a, and to print the interpolated image through the image forming engine 360.

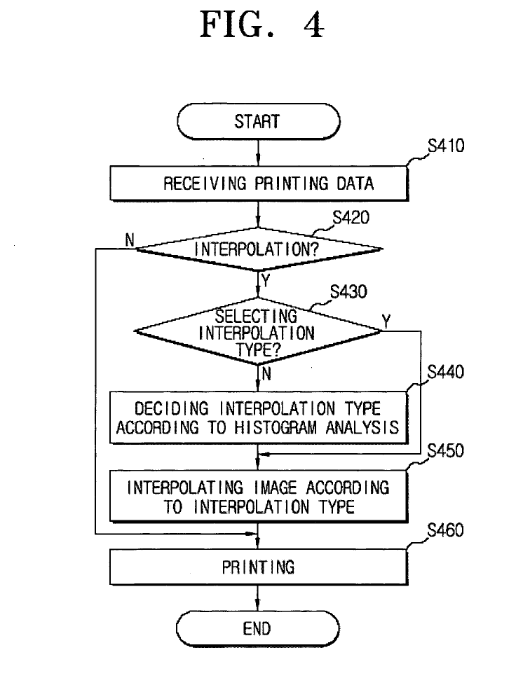

FIG. 4 is a flowchart to explain a control method of the image forming system according to the embodiment of the present invention.

If the user inputs a command for printing the image through the host inputting unit 230 or the image forming inputting unit 330, the printer driver 254 converts the printing image data to the bitmap data, and the host controlling unit 260 transmits the converted bitmap data to the image forming system through the host interfacing unit 220.

Accordingly, the image formation controlling unit 370 of the image forming apparatus 300 receives the printing data through the first image formation interfacing unit 310 (S410).

The image formation controlling unit 370 loads the emulation, and analyzes the received printing data and determines whether the command for interpolation printing is input as the printing option (S420). When the interpolation printing is selected, the image formation controlling unit 370 determines whether the interpolation type is selected (S430).

According to the embodiment of the present invention, the interpolation type and the interpolation ratio are input together with the command for interpolation printing, through the host inputting unit 230 or the image formation inputting unit 330.

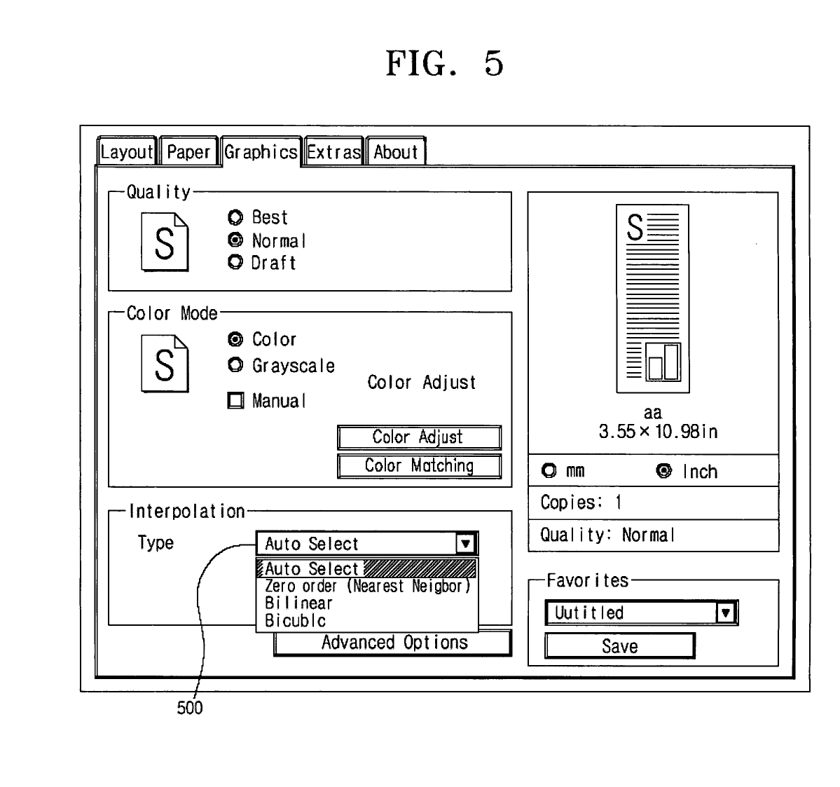

FIG. 5 is one example of a printing option screen provided by the printer driver 254. As shown in FIG. 5, the printing option screen is a user interface including a plurality of menus to allow for the inputting of various selections for printing. In particular, the printing option screen provides a selection window 500 to allow for a selection of the interpolation type and to allow for a selection of the interpolation type such as the zero-order type, the bilinear type and the bicubic type, or to allow for a selection of an Auto Select in which the interpolation type is automatically selected.

When the interpolation type is not selected, that is, when the Auto Select is selected in the above example, the image formation controlling unit 340 analyzes the printing data through the emulation 352, confirms an interpolation ratio, and determines the original size of the target bitmap image to be interpolated and the size of the image to be interpolated. The image formation controlling unit 340 analyzes a histogram of the bitmap image through the RIP 372 to determine the appropriate interpolation type (S440). Of course, the use of the histogram is not required and other devices may be used to analyze the bitmap image.

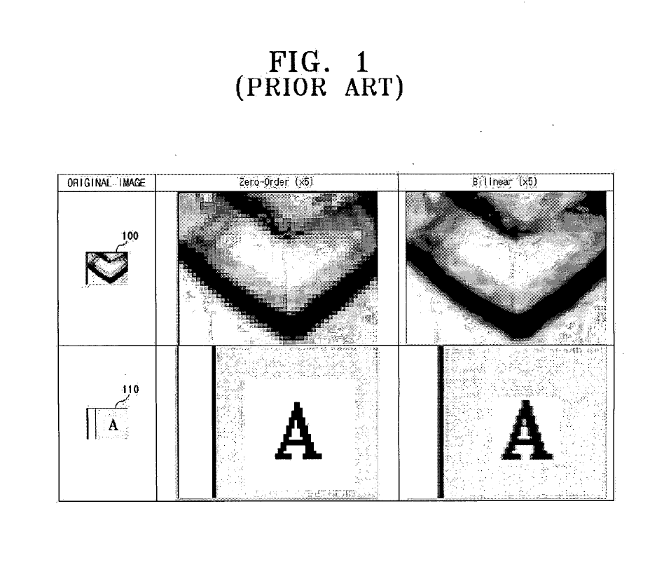

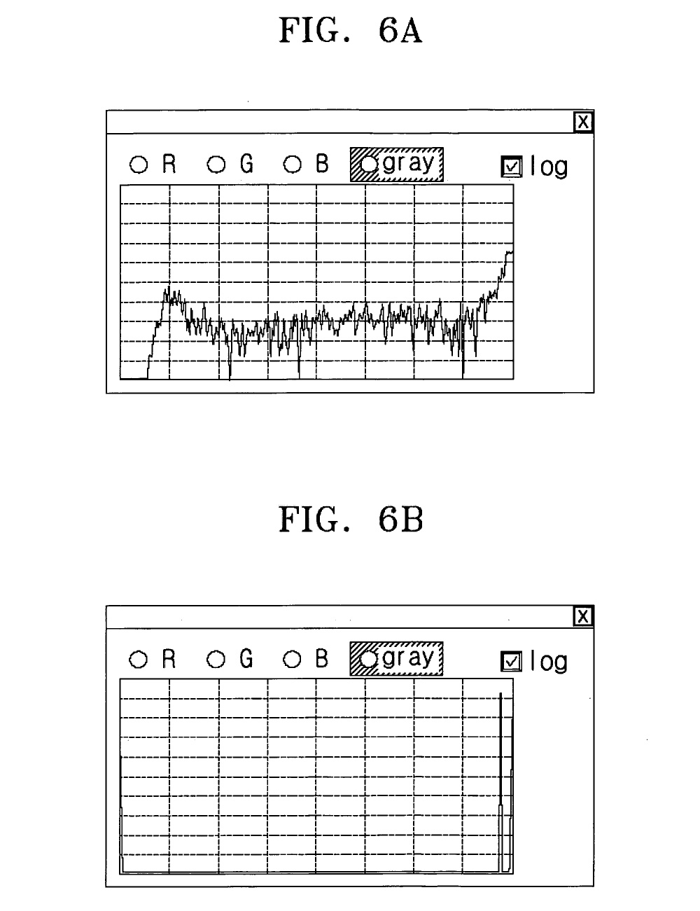

FIGS. 6A and 6B illustrate a histogram of two bitmap images. The histogram in FIG. 6A relates to pixel values of each pixel of the photo generation type images 100 of FIG. 1, and FIG. 6B relates to pixel values of each pixel of the graphic generation type images 110 of FIG. 1.

Referring to FIGS. 1A and 6B, in a comparison between histograms to classify the image into the graphic generation type image and the photo generation type image, FIG. 6A, which is the photographic image, shows a complicated picture of a histogram with many peaks for all the areas of pixel values. FIG. 6B, which is the graphical image, shows a simple picture of a histogram with just a few peaks for particular pixel values.

Accordingly, it is possible to determining whether the target image is the photographic image or the graphic image, by classifying the type of the image as either the graphic image or the photographic image. The classifying uses an application of a predetermined threshold value using a experimental value for the number of peaks in the histogram of the image, a consideration of the distribution of the pixel value indicated by the peak, and calculation of a complexity of the histogram form. The graphic image is then applied with the zero-order type, and the photographic image is applied with the bilinear type or bicubic type.

The image formation controlling unit 370 interpolates the corresponding bitmap image according to the interpolation type determined through the RIP 372, generates the interpolated bitmap image (S450) and prints the interpolated bitmap image through the image forming engine 360 (S460).

According to aspects of the control method of an image forming system and an image forming system, as described above, a quality of interpolated images is improved and resources and time necessary for image interpolation are saved, by deciding an appropriate interpolation type according to the type of a target image to be interpolated. Further, according to aspects of the present invention, a user-friendly interface is provided by not selecting the interpolation type or by selecting an automatic selection type, in order to automatically judge the image generation type and interpolate the image based on the result of the judging.

Although a few embodiments of the present invention have been shown and described, it would be appreciated by those skilled in the art that changes may be made in these embodiments without departing from the principles and spirit of the invention, the scope of which is defined in the claims and their equivalents.

What is claimed is:

1. A method of controlling an image forming system, comprising:
receiving printing data according to a command for interpolation printing;
analyzing the received printing data and determining an appropriate interpolation type based on the analysis;
interpolating the image according to the determined interpolation type; and
printing the interpolated image.

2. The control method according to claim 1, wherein the interpolation type comprises a zero-order interpolation type a bilinear interpolation type, and a bicubic interpolation type.

3. The control method according to claim 1, wherein the printing data is one of a graphical image or a photographical image.

4. The control method according to claim 3, wherein the analyzing of the received printing data comprises using a histogram of the printing data to determine whether the printing data is the graphical image or the photographical image.

5. The control method according to claim 4, wherein if the printing data is the graphical image, the zero-order type is determined to be the interpolation type.

6. The control method according to claim 4, wherein if the printing data is the photographical image, either the bilinear type or the bicubic type is determined to be the interpolation type.

7. The control method according to claim 1, further comprising:
inputting the command for interpolation printing for interpolating and printing the image, and providing a user interface to allow for a selection of the interpolation type.

8. The control method according to claim 1, wherein the determining of the interpolation type is performed by one of the image forming system or a host apparatus connected to the image forming apparatus.

9. A method of controlling an image forming system for processing and printing an image, the method comprising:
generating printing data according to a command for interpolation printing;
analyzing the received printing data and determining an appropriate interpolation type based on the analysis;
interpolating the image according to the determined interpolation type; and
printing the interpolated image.

10. The control method according to claim 9, wherein the interpolation type comprises a zero-order interpolation type or one of a bilinear interpolation type and a bicubic interpolation type.

11. The control method according to claim 9, wherein the printing data is one of a graphical image and a photographical image.

12. The control method according to claim 11, wherein the analyzing of the received printing data comprises using a histogram of the printing data to determine whether the printing data is the graphical image or the photographical image.

13. The control method of claim according to claim 12, wherein if the printing data is the graphical image, the zero-order type is determined to be the interpolation type.

14. The control method according to claim 12, wherein if the printing data is the photographical image, either the bilinear type or the bicubic type is determined to be the interpolation type.

15. The control method according to claim 9, further comprising:
inputting the command for interpolation printing for interpolating and printing the image, and providing a user interface to allow for a selection of the interpolation type.

16. A method of interpolating printing data, comprising:
analyzing the printing data to determine whether the printing data is graphical or photographical;
if the printing data is determined to be graphical, interpolating the printing data according to a zero-order interpolation method;
if the printing data is determined to be photographical, interpolating the printing data according to either a bilinear interpolation method or a bicubic interpolation method; and
printing the interpolated printing data.

17. An image forming system, comprising:
a host apparatus to interpolate an image according to interpolating instructions or, in the absence of the instructions, to determine whether the image to be interpolated is graphical or photographical, and to automatically select a method of interpolating in accordance with the determination, and to interpolate the image in accordance with the instructions or the automatically selected method so as to generate the printing data; and
an image forming apparatus, coupled to the host apparatus, to form an image based on printing data.

18. The system according to claim 17, wherein the image forming apparatus comprises a printer and/or a multifunctional printer (MFP), and wherein the host apparatus comprises a desktop computer, a laptop, and/or a personal digital assistant (PDA).

19. The system according to claim 17, wherein the host apparatus and the image forming system are coupled via a wired or wireless local area network (LAN).

20. The system according to claim 17, wherein the host apparatus comprises:
a first host interfacing unit to allow the host apparatus to be connected to an external device from which data is receivable;
a second host interfacing unit to couple the host apparatus to the image forming apparatus;
a host inputting unit to allow the user to input the instructions;
a host displaying unit to display results of processing operations done at or by the host apparatus to the user;
a host storing unit including a nonvolatile memory to store control programs and a volatile memory to store data processed in operations of the various control programs; and
a host controlling unit including a raster image processor to interpolate the image.

21. The system according to claim 20, wherein the first and second host interfacing units comprise a universal serial bus (USB) port, a parallel port, a personal system/2 (PS2) port and/or a local area network (LAN) card.

22. The system according to claim 20, wherein the host displaying unit comprises a cathode-ray tube (CRT) monitor or a liquid crystal display (LCD) monitor, the image forming apparatus comprises a printer driver to drive image forming operations, and the host displaying unit displays a printing option screen to allow for a selection of various options for printing provided by a printer driver of the image forming apparatus.

23. The system according to claim 22, wherein the printing option screen comprises an interpolation type selection item to allow for a selection of an image interpolation type and an image interpolation ratio.

24. An image forming apparatus to form an image based on printing data by interpolating an image according to instructions to employ a method of interpolating desired by a user of the apparatus or, in the absence of the instructions, to determine whether the image to be interpolated is graphical or photographical, and to automatically select a method of interpolating in accordance with the determination, and to interpolate the image in accordance with the desired or automatically selected method so as to generate the printing data.

25. The image forming apparatus according to claim 24, wherein the image forming apparatus comprises:
a first image formation interfacing unit to couple the image forming apparatus to a host apparatus;
a second image formation interfacing unit to connect the image forming apparatus to an external device;
an image formation inputting unit through which the user inputs the instructions;
an image formation displaying unit to display a result of an operational performance of the image forming apparatus;
an image formation storing unit including a nonvolatile memory that stores various control programs, and a volatile memory that stores data processed when the various control programs operate;
an image forming engine to print the interpolated image on a recording medium through a predetermined printing process; and
an image formation controlling unit including a raster image processor to interpolate the image.

26. The image forming apparatus according to claim 25, wherein the image formation displaying unit comprises a cathode-ray tube (CRT) monitor or a liquid crystal display (LCD) monitor and provides a user interface to the user.

27. The image forming apparatus according to claim 25, wherein the nonvolatile memory stores an emulation, such that, when bitmap data related to the image to be interpolated is transmitted from the host apparatus, the image formation controlling unit loads the emulation, analyzes the bitmap data and determines the appropriate interpolation method, the raster image processor using the received bitmap data, to interpolate the image.
